(19) United States
(12) Patent Application Publication
(10) Pub. No.: US 2025/0155632 A1
(43) Pub. Date: May 15, 2025

(54) WAVEGUIDE MODIFICATION AT FINAL PROCESSING

(71) Applicant: GOOGLE LLC, Mountain View, CA (US)

(72) Inventor: Thomas Hoekman, Redwood City, CA (US)

(21) Appl. No.: 18/505,223

(22) Filed: Nov. 9, 2023

(51) Int. Cl. F21V 8/00; G02B 5/18

(52) U.S. Cl. CPC G02B 6/0065; G02B 5/1857

(57) ABSTRACT

Waveguide modification includes modifying waveguide combiners, output coupler, and pupil expander regions, which contain diffraction gratings, based on user and display characteristics during manufacturing. The diffraction grating is generally configured to combine received display light, representing an image for display, and directs the combined light to a location where the image can be comfortably viewed by the user. Because the desired location for the display can vary based on characteristics of the user, the diffraction grating is modified during manufacturing, such as by covering portions of the grating, to tailor the characteristics of the diffraction grating for a particular user or group of users.

### BACKGROUND

Waveguides are used in a variety of applications and devices, with differing potential user bases. For example, some waveguides are employed in head-wearable displays (HWDs), where they are used to generate a virtual augmented reality (AR) image when viewed through a lens. The waveguide is used to direct light toward the lens, such that the AR images are perceived through the lens by the user at some distance, determined by the focal length of the lens. In order to control movement of light within the waveguide, diffraction gratings are used to couple light into and out of the waveguide. To accommodate a larger user base, the diffraction gratings are placed on the waveguide such that a large eyebox is generated, meaning that the full virtual image can be seen from a range of eye positions. This ensures that a wide variety of users can use the device. The characteristics of the HWD also drive the area and placement of the gratings on the waveguide. For example, the larger the field of view (FOV) of the HWD, the larger the area of the grating regions on the waveguide. Similarly the placement (angle) of the displayed virtual image affects the position and relative orientation of the grating regions on the waveguide. As a result, distinct master molds of the waveguide diffractive structures are required for each HWD design (FOV, virtual image placement) and/or target user base. However, developing multiple masters increases the cost of manufacture as these typically require substantial capital expenditure to fabricate. In addition, significant overhead and duplication can occur in production lines where multiple masters are used to create multiple waveguide designs. For example, separate replication lines might be established for each design. Finally, decisions must be made early in the production process regarding the quantities of each design to produce. This can lead to inefficiencies in storage space to accommodate inventory for each waveguide manufactured. Conversely, designing a single waveguide to support multiple fields of view and/or a large eyebox reduces the performance of the waveguide in use cases where a smaller FOV and/or eyebox is used.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a diffraction grating disposed on a waveguide and having a coating deposited on diffraction features, in accordance with some embodiments.

FIG. 2 is a diagram of an example for placement of the diffraction grating of FIG. 1 within an eyepiece and the coating surrounding a preserved region, in accordance with some embodiments.

FIG. 3 is a diagram of a display system housing a projector system configured to project images toward the eye of a user, in accordance with some embodiments.

FIG. 4 is a flow diagram illustrating a method for modifying a waveguide combiner, in accordance with some embodiments.

### DETAILED DESCRIPTION

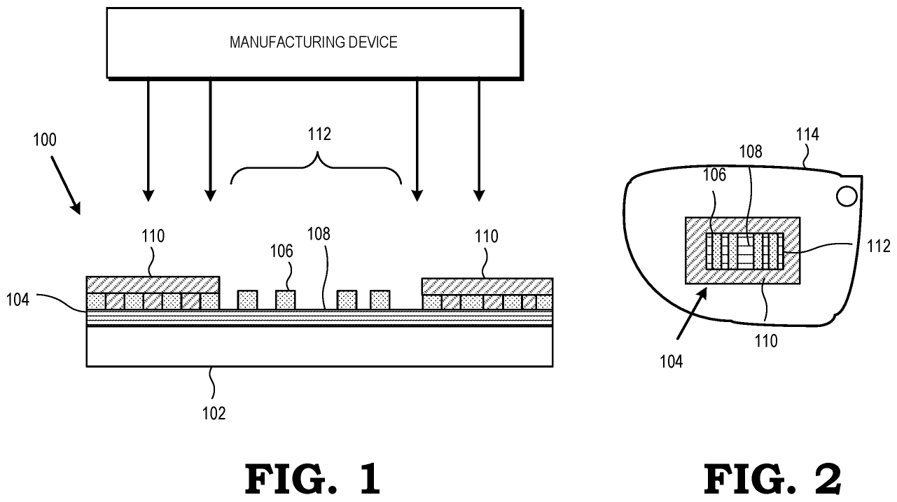

FIGS. 1-4 illustrate techniques for modifying waveguide combiners, output coupler, and pupil expander regions, which in some embodiments contain diffraction gratings, based on user and display characteristics during manufacturing. The diffraction grating is generally configured to combine received display light, representing an image for display, and is further configured to direct the combined light to a location where the image can be comfortably viewed by the user. Because the desired location for the display can vary based on characteristics of the user, the diffraction grating is modified during manufacturing, such as by covering portions of the grating, to tailor the characteristics of the diffraction grating for a particular user or group of users. This approach allows a single master to be used to manufacture display systems that are tailored to a wide variety of users, thus saving manufacturing costs and improving the user experience.

To illustrate, under conventional methodology, multiple masters of a waveguide are used to create a range of HWDs for users having different physical characteristics. In particular, conventional approaches employ different masters, each having different outcoupler sizes and/or locations, to accommodate users with different interpupillary distances (IPD) or other human factors. However, having multiple masters to create numerous waveguides for a variety of HWDs increases costs for manufacture and increases operational requirements such as storage space to support additional HWD product lines. However, unlike the conventional method of using multiple masters to develop different HWDs, using the techniques applied herein, multiple waveguides that support different IPDs and display characteristics can be manufactured using a single master.

Using the techniques described herein, the master is designed such that the diffraction grating regions are larger than those in a master designed in the conventional method that targets the narrowest supported user population group and/or field of view. For sake of brevity, the diffraction grating will hereinafter be referred to as the grating. Thus, the grating has a larger size than required to meet product specifications. However, by creating the grating with a larger size, the grating is large enough to fit all use cases, including a range of IPDs or HWD characteristics. However, for each of these use cases, a significant portion of this enlarged grating region is wasted or unused because regions that do not intersect with the projected eyebox of the user will not diffract light to the user's eye. Thus, the grating with the larger size is modified or customized based on, for example, the IPD or type of HWD. Specifically, the larger grating has regions or portions that are modified through erasure. Erasure is herein defined as a process of depositing material to neutralize (i.e., erase, remove, make transparent) an optical structure that is being covered, which in various embodiments is the grating. During processing, and in particular, at a final processing step (i.e., no additional modifications, additions, or alterations to the waveguide are made subsequent to this step), the diffraction grating is modified based on modification data. Modification data includes a variety of factors, such as a type of HWD (e.g., prescription glasses, sports glasses), physical factors including IPD, positioning during use of the eyewear (i.e., position of the waveguide 102 with respect to eyes of a user), and the like. By saving modification of the waveguide master to the final processing step, manufacturing is streamlined and simplified, and many products can be created during the final processing step. Thus, different product lines of waveguides are created using the same waveguide master. In some embodiments, for example, the waveguide is used in eyeglasses to redirect light to generate augmented reality (AR) images for viewing in combination with a real world environment as perceived through the eyeglasses. Moreover, the waveguide is adjusted according to the type of the eyeglasses. Specifically, for example, in some embodiments, the waveguide master is modified for use in sports eyeglasses and, in other embodiments, the waveguide master is modified for use in prescription eyeglasses.

To reduce the need for multiple waveguide masters, modifying the waveguide includes modifying the diffraction grating by depositing a coating on the diffraction grating. The coating is applied during the final processing step of manufacture or development of the grating based on the modification data. Specifically, for example, the coating is applied on regions of the grating that does not affect the FOV of the intended user of the HMD. The coating eliminates or substantially reduces the diffraction efficiency of the grating in the regions of the grating where the coating is applied. This is achieved by selecting a coating material that is substantially similar in refractive index to the material of the grating, thereby smoothing the index contrast of the diffraction grating's features. Alternatively, the grating could be removed or etched away from the unused regions. In the aforementioned example, the modification data identifies the regions of the grating that are not used or have no effect during use. As such, by using a single waveguide master and performing modification at, or near, the final processing or near final step of manufacture, cost of manufacture is reduced and the required overhead production costs of the line are reduced by consolidating prior process steps, and inventory space for storage of products may also be reduced.

FIG. 1 illustrates a waveguide 100 after modification during processing. In the depicted embodiment, the waveguide 100 includes a substrate 102. During processing for manufacture, the waveguide 100 is replicated from a master mold. Additionally, a diffraction grating 104 (herein referred to as grating 104) is disposed on the substrate 102. In some embodiments, the grating 104 is an outcoupler grating (herein referred to as outcoupler or OC). The grating 104 couples a portion of the light out of the waveguide 100 towards, for example, an eye of a user (not shown). However, in other embodiments, the grating 104 is an incoupler grating (herein referred to as an incoupler or IC). In the case of an incoupler, the grating 104 couples a portion of the light out into the waveguide 100 towards, for example, an eye of a user (not shown). In other embodiments, the grating 104 is an exit pupil expander (EPE) grating.

A coating 110 is deposited (i.e., mounted, installed) onto at least one region or portion of the grating 104 using a manufacturing device 120, such as a processing device (i.e., a processor, a computer processing unit (CPU), a multi-core processor, a microcontroller, a graphics processing unit (GPU), or any other parallel processing unit) and/or a construction device (i.e., robotics, gears, levers, tools, presses, fabrication equipment, microfabrication equipment, deposition, etching, implantation operations, and the like) that forms the waveguide 100. Specifically, in some embodiments, the coating 110 is deposited by the manufacturing device on a portion of the plurality of diffraction features 106 and/or a portion of the plurality of grooves 108. The substrate of the grating 104 that receives the coating 110 varies depending on how much a diffraction efficiency (DE) of the grating 104 is required to be erased (i.e., eliminated or weakened). In other words, the coating 110 prevents or substantially reduces the diffraction of light through at least one region of the grating 104 that is covered with the coating 110 in response to depositing the coating 110 on the at least one region of the grating 104. Furthermore, the coating 110 minimizes visual artifacts. To illustrate, depositing the coating 110 at particular regions of the grating 104 eliminates diffraction of light through those regions. In most cases, passage of light through the grating 104 can be subject to scattering due to how light diffracts from the grating 104. Accordingly, the reduction of light diffracting from the grating 104 minimizes the likelihood for such visual artifacts including noise, distortion, color banding, stray light, and the like. Different waveguide products can be created from the single waveguide master 100 based on the application of the waveguide product. By increasing the size of the grating 104 to be applicable to any use case, such as any IPD. Using the large grating 104 as a baseline, the grating 104 can be modified by depositing the coating 110 (i.e., covering the grating 104 with the coating 110) on regions of the grating 104 that is not used based on the IPD. To illustrate, a first user with a small IPD requires an adjustment to the grating 104 different from an adjustment to the grating 104 for a second user with a larger IPD than the first user. Additionally, the first user is unable to use the grating 104 modified for the second user, and the second user is unable to use the grating 104 modified for the first user due to difference in IPD. Therefore, by depositing the coating 110 on the baseline grating 104, the grating 104 is adapted for different IPDs.

The coating 110 is deposited during a final (or near final) processing step of manufacture by the manufacturing device 120. In some embodiments, the coating 110 is deposited through application of a stencil on the manufacturing device. Specifically, the coating 110 is deposited through a stencil onto the grating 104. As such, the coating 110 is disposed on the grating 104 at portions of the grating 104 based on holes within the stencil. In particular, the coating 110 is deposited based on modification data. The modification data includes a variety of factors, such as a type of eyewear (e.g., eyeglasses), physical factors including IPD, positioning during use of the eyewear (i.e., position of the waveguide 100 with respect to eyes of a user), and the like. To illustrate, the type of eyeglasses affects a field of view (FOV) and the location of the coating 110 for the grating 104 with respect to sports eyeglasses differs from the location of the coating 110 for the grating 104 with respect to prescription eyeglasses due to sports eyeglasses having a small FOV (with respect to prescription eyeglasses) and prescription eyeglasses having a large FOV (with respect to the sports eyeglasses). The projection of the virtual image from the eyebox touches lenses on the sports eyeglasses in a different location than where it would touch lenses on prescription eyeglasses. Furthermore, other factors such as IPD are used to determine placement of the coating 110. For example, in applications using HWDs, an eyebox must be considered to determine where eyes comfortably view images displayed on the HWD. The eyebox needed to see an image through the grating 104 does not require an entire size (e.g., length, width) of the grating 104. In other words, the eyebox through the grating 104 is at least partially based on the IPD, and therefore, the coating 110 is deposited on regions of the grating 104 that are determined to have no effect on the user's eyebox. Also, positioning during use of the eyewear affects the eyebox. For example, location of eyewear on the user (e.g., nose) affects the eyebox as it has a direct impact on distance of the waveguide 100 and/or the grating 104 from the eyes of the user, as well as the incidence of light on the grating 104. Stated differently, a direction and angle of the eyewear on the user affects how the user perceives images rendered on the eyewear and how any objects in an environment are perceived based on how light is received in the eyewear.

In other embodiments, the coating 110 is deposited using microlithography (uLithography). Specifically, the coating 110 is deposited on selected regions of the grating 104 as a pattern of film over the grating 104. As such, the coating 110 is disposed on the grating 104 through the pattern of film using uLithography. In this manner, the regions of the grating 104 receiving the coating 110 is based on the modification data described above with respect to the stencil process. Further methods to deposit the coating 110 includes ink jet material deposition, which can reduce cost of production and an amount of material used. In particular, ink jet uses drop formation of a material, such as the coating 110 to dispense onto a substrate, such as the grating 104. Another method to deposit the coating 110 includes applying a resin to the coating 110 and etching the regions over the grating 104.

In some embodiments, the material of the coating 110 includes any material that reduces the grating 104 DE by reducing index contrast. In regions of the grating 104 receiving the coating 110, the refractive index is equivalent to a refractive index of the grating 104. In order to reduce the DE of the coating 110, in some embodiments, the coating 110 includes a multilayer dielectric that reduces or minimizes scattering of light from the grating 104. Specifically, the coating 110 prevents light from diffracting or reflecting at regions of the grating 104 where the coating 110 is deposited. Accordingly, through selective application of the coating 110 to regions of the grating 104, those regions are subject to erasure. Stated differently, the regions of the grating 104 where the display image FOV does not intersect the use case specific eyebox is erased in response to deposit of the coating 110 on those regions. As a result, the efficiency of the remaining grating outcoupler 104 is improved. Specifically, light is extracted through a preserved region 112 of the grating 104. The preserved region 112 is a region of the grating 104 that is not covered by (i.e., has an absence of) the coating 110. Moreover, the location of the preserved region 112 is based on the modification data. For example, in the case of the modification data pertaining to eyepieces (i.e., lenses), the location of the preserved region 112 is different between a left eyepiece (i.e., lens) and a right eyepiece (i.e., lens). In particular, the FOV for the left eyepiece is different from the FOV for the right eyepiece. Therefore, the preserved region 112 and correspondingly the location for depositing the coating 110 changes between the left eyepiece and the right eyepiece. Additionally, IPD is not the same for every user. For example, in most cases, the IPD for a child is smaller than the IPD for an adult due to the child having a head size smaller than the head size of the adult. Conversely, the IPD for the adult is greater than the IPD for the child because of a larger head size of the adult with respect to the head size of the child. As such, the useful eyebox of the adult is different from the useful eyebox of the child. To accommodate the target eyebox of the adult and that of the child, the preserved region 112 is adjusted to fit either the target eyebox of the adult or the child, respectively. Thus, the preserved region 112 and the location of the coating 110 is based on the modification data.

FIG. 2 illustrates an example layout for placement of the grating 104 within an eyepiece 114 and the coating 110 surrounding the preserved region 112, in accordance with some embodiments. In the depicted example, the eyepiece 114 is a right eyepiece. However, similar features and techniques described herein are applicable to any other type of eyepiece, such as a left eyepiece. The waveguide combiner 102 (not shown) and the grating 104 are disposed (i.e., installed, mounted, inserted) within the eyepiece 114. For simplicity of understanding, the preserved region 112 is illustrated as disposed at a center portion of the grating 104 and the coating 110 has been deposited on regions of the grating 104 surrounding the preserved region 112. However, it will be appreciated that alternative configurations are made based on the modification data that determines where the FOV intersects the eyebox. For example, in some embodiments, the preserved region 112 comprises a first half (e.g., a left half side) of the grating 104 and the coating 110 is deposited on a second half (e.g., a right half side) of the grating 104. In some embodiments, the coating 110 is deposited on the first half of the grating 104 and the preserved region 112 is disposed on the second half of the grating 104. In other embodiments, the preserved region is disposed on an upper half (i.e., toward a top portion of the eyepiece 114) of the grating 104 and the coating 110 is deposited on a lower half (i.e., toward a bottom portion of the eyepiece 114) of the grating 104. In yet another embodiment, the coating 110 is deposited on the upper half of the grating 104 and the preserved region 112 is disposed on the lower half of the grating 104.

As highlighted above, the preserved region 112 diffracts or otherwise scatters display light propagating within the waveguide, while the regions on the grating 104 with the coating 110 do not scatter this light, allowing it instead to continue propagating through the waveguide. Thus, in the depicted example, the display light is extracted through the center portion of the grating 104. Moreover, the grating 104 is described as an OC. Therefore, the grating 104 couples the light from the waveguide combiner 102 to exit away from the grating 104 through the preserved region 112. However, the coating 110 prevents the extraction of light through regions of the grating 104 where the coating 110 is located, which includes all portions of the grating 104 surrounding the center portion. As such, the efficiency of the waveguide 100 is improved due to less wasted light in regions of the grating 104 covered by the coating 110 that does not contribute to the eyebox and/or correspond to the display FOV. Stated differently, in response to deposition of the coating 110 on the regions of the grating 104 around the preserved region 112 based on the modification data, the efficiency of the waveguide 100 is improved.

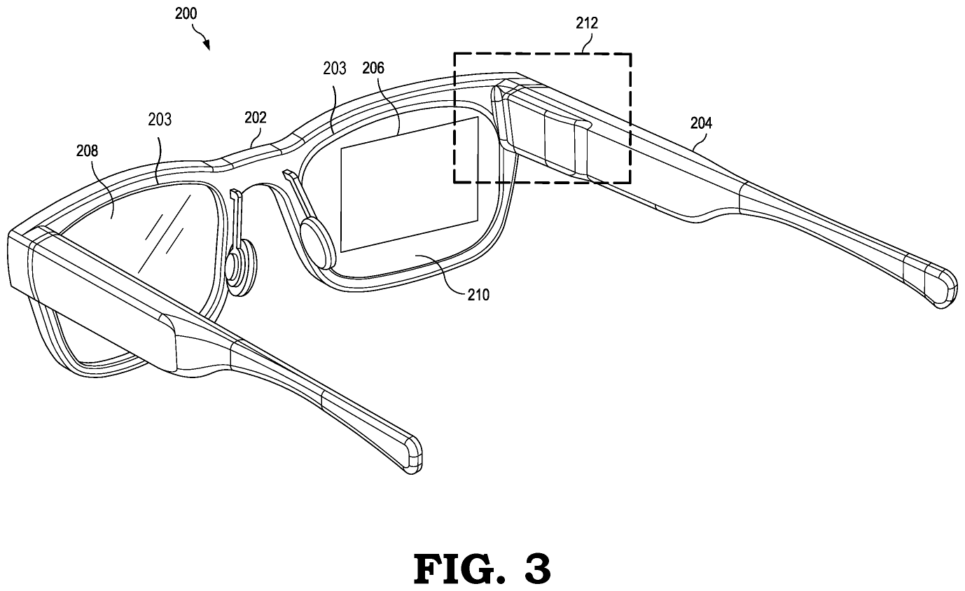

FIG. 3 illustrates a display system 200 having a frame 202 that includes a first arm 204, which houses a projection system configured to project display light representative of images toward an eye of a user, such that the user perceives the projected images as being displayed in a field of view (FOV) area 206 of a display at a first eyepiece 208 and/or a second eyepiece 210. In the depicted embodiment, the display system 200 is an HWD that includes the frame 202 configured to be worn on the head of a user and has a general shape and appearance of a pair of eyeglasses. The frame 202 contains or otherwise includes various components to facilitate the projection of such images toward the eye of the user, such as a light engine, a projector, an optical scanner, and a waveguide. In some embodiments, the frame 202 further includes various sensors, such as one or more front-facing cameras, rear-facing cameras, other light sensors, motion sensors, accelerometers, and the like. The frame 202 further can include one or more radio frequency (RF) interfaces or other wireless interfaces, such as a Bluetooth® interface, a Wi-Fi interface, and the like. Further, in some embodiments, the frame 202 further includes one or more batteries or other portable power sources for supplying power to the electrical components of the display system 200. In some embodiments, some or all of these components of the display system 200 are fully or partially contained within an inner volume of the frame 202, such as within the arm 204 in a region 212 of the frame 202. It should be noted that while an example form factor is depicted, it will be appreciated that in other embodiments the display system 200 may have a different shape and appearance from the eyeglasses frame depicted in FIG. 3.

In the depicted embodiment of FIG. 3, the frame 202 further includes a plurality of lens barrels 203. Each of the plurality of lens barrels 203 receives, stores, and houses the first lens 208 and/or the second lens 210. In other words, the first lens 208 and/or the second lens 210 detachably connects to the frame 202 within the plurality of lens barrels 203. In some embodiments, as will be described below, each of the plurality of lens barrels 203 includes circuitry and/or electrical components that receive the display light that is emitted into the first lens 208 and/or the second lens 210.

The first lens 208 and/or the second lens 210 are used by the display system 200 to provide an augmented reality (AR) display in which rendered graphical content can be superimposed over or otherwise provided in conjunction with a real-world view as perceived by the user through the first lens 208 and/or the second lens 210. For example, display light used to form a perceptible image or series of images may be projected by a projector of the display system 200 onto the eye of the user via a series of optical elements, such as a waveguide disposed at least partially within or otherwise connected to the first lens 208 and/or the second lens 210, one or more scan mirrors, and one or more optical relays. Thus, in some embodiments, the first lens 208 and/or the second lens 210 include at least a portion of a waveguide, such as the waveguide 100 described above with respect to FIG. 1, that routes display light received by an incoupler of the waveguide 100 to an outcoupler of the waveguide 100, which outputs the display light toward an eye of a user of the display system 200. Furthermore, the coating 110 as applied to the grating 104 affects the spatial region from which light exits the waveguide 100, and correspondingly, how the light lands on the first lens 208 and/or the second lens 210. The display light is modulated and scanned onto the eye of the user such that the user perceives the display light as an image. In addition, the first lens 208 and/or the second lens 210 are sufficiently transparent to allow a user to see through the lens elements to provide an FOV of the user's real-world environment such that the image appears superimposed over at least a portion of the real-world environment.

In some embodiments, the projector is a digital light processing-based projector, a microdisplay, scanning laser projector, or any combination of a modulative light source. For example, according to some embodiments, the projector includes a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be MEMS-based or piezo-based). The projector is communicatively coupled to the controller and a non-transitory processor-readable storage medium or a memory that stores processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 200. The projector scans light over a variable area, designated the FOV area 206, of the display system 200. The scan area size corresponds to the size of the FOV area 206 and the scan area location corresponds to a region of the first lens 208 and/or the second lens 210 at which the FOV area 206 is visible to the user. Generally, it is desirable for a display to have a wide FOV to accommodate the outcoupling of light across a wide range of angles. Herein, the range of different user eye positions that will be able to see the display is referred to as the eyebox of the display.

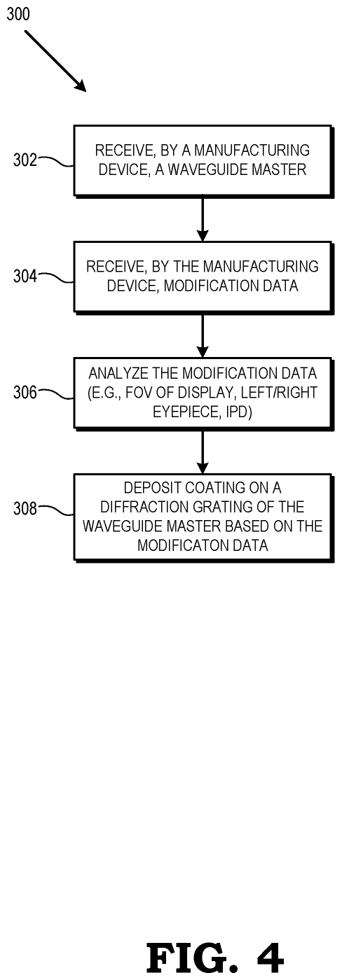

FIG. 4 illustrates a flow diagram depicting a method 300 for modifying the waveguide combiner, in accordance with some embodiments. The method 300 is described with respect to an example implementation of the waveguide 100 of FIG. 1. At block 302, a manufacturing device receives the waveguide 100 for processing and manufacturing. At block 304, the manufacturing device 120 receives the modification data, which is input from a manufacturer or preconfigured commands based on instructions defined in a computer program. At block 306, the manufacturing device analyzes the modification data to determine parameters on how to modify the waveguide 100 including at least one of the type of eyewear, IPD, FOV of the eyewear, positioning during use, and the like. At block 308, the manufacturing device deposits the coating 110 on the waveguide 100 based on the modification data at the final processing or near final step of manufacture. The manufacturing device 120 is configured to use stencil or uLithography to deposit the coating 110. The manufacturing device deposits the coating 110 on the regions of the grating 104 where the extracted display FOV does not intersect the target eyebox, such that regions of the grating 104 are erased in response to deposit of the coating 110 on those regions. Accordingly, the preserved region 112 is formed where the coating 110 is not deposited. As such, the efficiency of the waveguide 100 is improved due to less wasted light in regions of the grating 104 covered by the coating 110 that does not contribute to the eyebox. During the final process or near final process, different types of waveguide products can be created from the waveguide 100, such as an OC for a left eyepiece, an OC for a right eyepiece, a sports eyeglass, a prescription eyeglass, and the like.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a manufacturing device, a grating for a waveguide; and
depositing a coating on the grating based on modification data received by the manufacturing device at final processing for erasure of a region of the grating.

2. The method of claim 1, wherein receiving modification data comprises receiving the region on the grating that is erased based on an application of a waveguide product.

3. The method of claim 1, wherein receiving modification data comprises receiving at least one of a type of eyewear and physical factors.

4. The method of claim 1,
wherein a preserved region of the grating has an absence of the coating.

5. The method of claim 4, wherein depositing the coating on the region of the grating is based on a field of view (FOV).

6. The method of claim 4, wherein depositing the coating on the region of the grating is based on interpupillary distance (IPD).

7. The method of claim 1, wherein depositing the coating comprises depositing the coating through stencil or uLithography.

8. The method of claim 1, wherein depositing the coating through stencil or uLithography eliminates diffraction of light through a grating.

9. The method of claim 1, further comprising:
generating at least one of a left eyepiece or a right eyepiece from the waveguide.

10. The method of claim 1, wherein depositing the coating comprises depositing a dielectric coating that reduces scattering of light.

11. A method comprising:
forming, at a manufacturing device, a first waveguide based on a waveguide master;
connecting an enlarged grating to the first waveguide;
depositing a coating on unused regions of the enlarged grating for covering of the unused regions of the enlarged grating; and
one of:
imprinting a display system using the first waveguide and forming a second waveguide based on the first waveguide.
